(19) United States
(12) Patent Application Publication
(10) Pub. No.: US 2015/0221901 A1
(43) Pub. Date: Aug. 6, 2015

(54) POLYMER BATTERY PACK

(71) Applicant: SAMSUNG SDI CO., LTD., Yongin-si (KR)

(72) Inventors: Ho-Jae CHO, Yongin-si (KR); Bo-Hyun BYUN, Yongin-si (KR); Sung-Pyo HONG, Yongin-si (KR)

(21) Appl. No.: 14/596,838

(22) Filed: Jan. 14, 2015

(30) Foreign Application Priority Data
Feb. 4, 2014 (KR) 10-2014-0012437

(51) Int. Cl. H01M 2/02; H01M 10/42

(52) U.S. Cl. CPC H01M 2/0207; H01M 10/4257

(57) ABSTRACT

A battery pack including a pouch battery cell; a protective circuit module on a top side of the battery cell; a top case on the protective circuit module, the top case including a plurality of first coupling projections extending laterally outwardly therefrom; and a reinforcement sheath, the reinforcement sheath including a plurality of coupling holes therein, wherein the first coupling projections are in first coupling holes of the plurality of coupling holes, and the first coupling projections, together with the first coupling holes, couple the top case with the reinforcement sheath.

### CROSS-REFERENCE TO RELATED APPLICATION

Korean Patent Application No. 10-2014-0012437, filed on Feb. 4, 2014, in the Korean Intellectual Property Office, and entitled: “Polymer Battery Pack,” is incorporated by reference herein in its entirety.

### BACKGROUND

1. Field

Embodiments relates to a polymer battery pack.

2. Description of the Related Art

A battery pack may include a rechargeable battery cell and a protective circuit module configured to reduce the likelihood of and/or prevent overcharge or overdischarge of the battery cell.

A lithium ion battery or lithium polymer battery may be used as the battery cell. The protective circuit module may have a plurality of circuit elements for preventing overcharge or overdischarge of the battery cell.

### SUMMARY

Embodiments are directed to a polymer battery pack.

The embodiments may be realized by providing a battery pack including a pouch battery cell; a protective circuit module on a top side of the battery cell; a top case on the protective circuit module, the top case including a plurality of first coupling projections extending laterally outwardly therefrom; and a reinforcement sheath, the reinforcement sheath including a plurality of coupling holes therein, wherein the first coupling projections are in first coupling holes of the plurality of coupling holes, and the first coupling projections, together with the first coupling holes, couple the top case with the reinforcement sheath.

The top case may include a cover plate overlying the protective circuit module such that the protective circuit module is between the battery cell and the cover plate, and a side wall extending from the cover plate toward the battery cell, and the plurality of first coupling projections may extend from the side wall.

An outer side of the side wall may have a circumference that is less than a circumference of a parallel outer side of the cover plate.

The outer side of the side wall may be stepped inwardly by a first distance with respect to the outer side of the cover plate.

The first distance may be about equal to a thickness of the reinforcement sheath.

A height of each first coupling projection from the side wall may be greater than the thickness of the reinforcement sheath.

Each first coupling projection may have a height from the side wall that is greater than a depth of each first coupling hole.

The first coupling projections may be riveted with the first coupling holes such that an outer end of each first coupling projection is flattened and has a diameter that is greater than a diameter of each first coupling hole.

The flattened ends of the first coupling projections may protrude from an otherwise flat outer surface of the battery pack.

The reinforcement sheath may include a metal layer.

The metal layer may include aluminum, stainless steel, or copper.

The reinforcement sheath may include an adhesive layer on an inner side thereof.

The adhesive layer may include a material that is the same as a material included in the top case.

The battery pack may further include a bottom case on the battery cell, the bottom case being on a side of the battery cell that is opposite to the top case.

The bottom case may include a plurality of second coupling projections extending laterally outwardly therefrom, and the plurality of second coupling projections may be in second coupling holes of the plurality of coupling holes.

The bottom case may include a bottom cover plate on the battery cell such that the battery cell is between the bottom cover plate and the top case, and a side wall extending from the cover plate toward the top case, and the plurality of second coupling projections may extend from the side wall.

The side wall of the bottom case may include a narrow-side extension part, the narrow-side extension part extending from the bottom cover plate along narrow sides of the battery cell.

The narrow-side extension part of the bottom case may be coupled with narrow sides of the top case.

The coupling holes may be holes penetrating completely through the reinforcement sheath, or holes only partially penetrating the reinforcement sheath.

A diameter of a portion of each first coupling projection in each first coupling hole may be smaller than a diameter of each coupling hole.

### BRIEF DESCRIPTION OF THE DRAWINGS

Features will be apparent to those of skill in the art by describing in detail exemplary embodiments with reference to the attached drawings in which:

FIG. 1 illustrates a perspective view of a polymer battery pack according to an embodiment.

FIG. 2 illustrates an exploded perspective view of the polymer battery pack according to the embodiment.

FIG. 3A illustrates a partial perspective view showing in detail a top case and a reinforcement sheath in the polymer battery pack according to the embodiment.

FIG. 3B illustrates a sectional view taken along line A-A of FIG. 3A.

FIG. 4A illustrates a partial perspective view showing a state in which the reinforcement sheath surrounds the top case according to the embodiment.

FIG. 4B illustrates a sectional view taken along line A-A of FIG. 4A.

FIG. 5A illustrates a partial perspective view showing a state after a plurality of projections of the top case are thermally compressed according to the embodiment.

FIG. 5B illustrates a sectional view taken along line A-A of FIG. 5A.

FIG. 6 illustrates an exploded perspective view of a polymer battery pack according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween.

According to an embodiment, it is possible to help ensure the reliability of attachment when, e.g., a metal label for strength reinforcement, is attached to a pouch-type cell, and to reduce a manufacturing cost and the number of processes. Hereinafter, a polymer battery pack according to an embodiment will be described in detail with reference to the accompanying drawings.

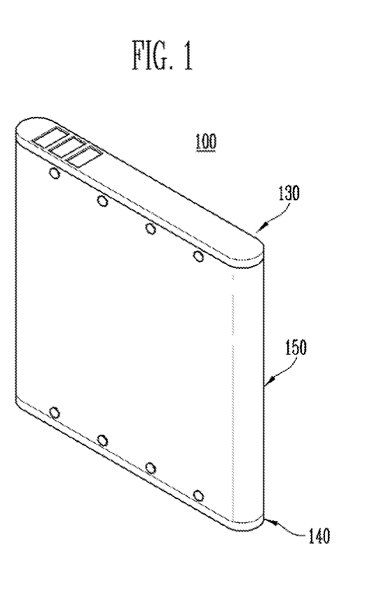

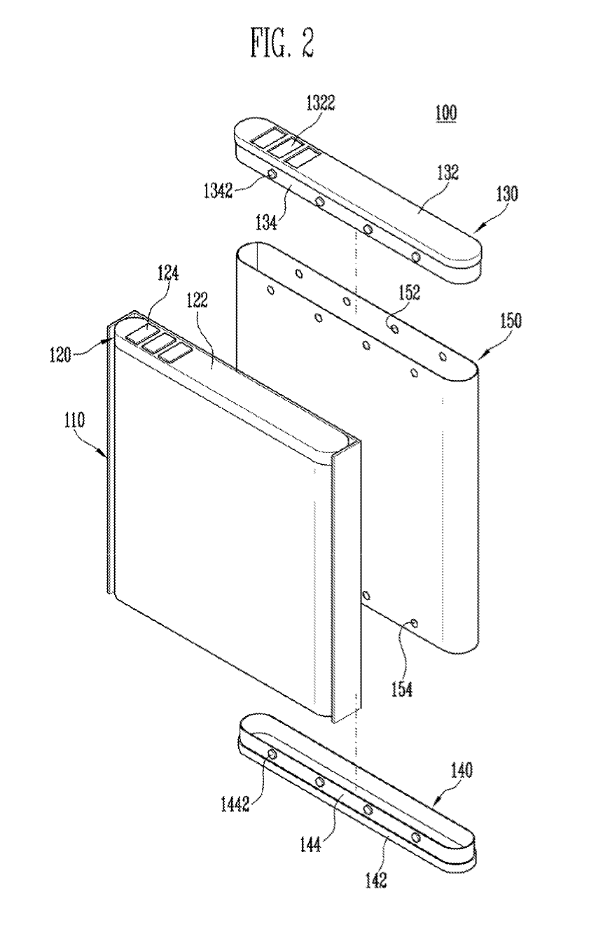

FIG. 1 illustrates a perspective view of a polymer battery pack 100 according to an embodiment. FIG. 2 illustrates an exploded perspective view of the polymer battery pack 100 according to the embodiment.

As shown in FIGS. 1 and 2, the polymer battery pack 100 according to this embodiment may include a pouch-type battery cell 110, a protective circuit module 120, a top case 130, a bottom case 140, and a reinforcement label or reinforcement sheath 150.

Although it is described with respect to the present embodiment that, for convenience of illustration, the pouch-type bare cell 110 is a lithium ion polymer battery, the embodiments are not limited thereto.

An electrode tab (not shown) having a predetermined length may be exposed to the top of the pouch-type bare cell 110, and the charging and discharging of the pouch-type bare cell 110 may be made through the exposed electrode tab.

The protective circuit module 120 may be disposed on the top of the pouch-type bare cell 110. The protective circuit module 120 may be electrically connected to the electrode tab (not shown) of the pouch-type bare cell 110 to control a charging/discharging state of the pouch-type bare cell 110.

The protective circuit module 120 may include a printed circuit board 122, and a circuit (not shown) for allowing the charging state of the pouch-type bare cell 110 to be uniform by controlling the charging/discharging of the pouch-type bare cell 110, a protection circuit such as a circuit (not shown) for preventing overdischarge and overcharge of the pouch-type bare cell 110, or the like may be formed on the printed circuit board 122.

The protective circuit module 120 may include a protection element such as a thermistor or temperature fuse. The protective circuit module 120 may help prevent risks, e.g., fracture and ignition of the battery, by cutting off current, using the protection element, when the voltage/current of the battery is out of a regulation range due to an increase in temperature of the battery, excessive charging/discharging of the battery, or the like.

The protective circuit module 120 may include a terminal 124 mounted to be electrically connected to the electrode tab of the pouch-type bare cell 110.

The top case 130 according to this embodiment may be disposed on the top of the protective circuit module 120 to accommodate the protective circuit module 120.

In an implementation, the top case 130 may include a cover plate 132 and a side wall 134.

For example, the cover plate 132 may be formed in a shape similar to that of the printed circuit board 122 of the protective circuit module 120, and may include a through-hole 1322 formed in an area corresponding to or overlying the terminal 124 of the protective circuit module 120.

The terminal 124 may be exposed through the through-hole 1322, and accordingly, power may be supplied to an external device through the exposed terminal 124.

The side wall 134 may be integrally formed with the cover plate 132 at the bottom of the cover plate 132. The side wall 134 may have a size smaller than an entire circumference of the cover plate 132.

For example, the side wall 134 according to this embodiment may be formed with a step difference with respect to the cover plate 132, so as to offset a thickness of the reinforcement sheath 150 surrounding the top case 130. For example, an outer side of the side wall 134 may have a circumference that is less than a circumference of a parallel outer side of the cover plate 132. In an implementation, the step difference may be equal to or about equal to a thickness of the reinforcement sheath 150. For example, the outer side of the side wall 134 may be stepped inwardly by a first distance with respect to the outer side of the cover plate 132.

Accordingly, even after the reinforcement sheath 150 (described below) surrounds side portions of the pouch-type bare cell 110 and the top case 130, the polymer battery pack 100 may have an entirely flat outer surface.

In an implementation, the side wall 134 may be formed together with the cover plate 132 without any step difference. For example, the thickness of the reinforcement label 150 surrounding the side wall 134 may not be offset, but rather reflected as the total thickness of the polymer battery pack 100.

In an implementation, the side wall 134 may include a plurality of projections (e.g., coupling projections) 1342 formed thereon.

As will be described in greater detail below, the plurality of projections 1342 may be respectively mounted in a plurality of grooves or holes 152 in an upper end of the reinforcement sheath 150, and may then be thermally compressed, so that bonding between the reinforcement sheath 150 and the pouch-type bare cell 110 may be more easily made.

In a similar manner to the top case 130, the bottom case 140 may be bonded to or coupled with the pouch-type bare cell 110 at the bottom of the pouch-type bare cell 110. The bottom case 140 may accommodate a bottom end of the pouch-type bare cell 110.

For example, the bottom case 140 according to an embodiment may also include a cover plate 142 and a side wall 144. In this case, the bottom case 140 may be formed in a shape similar to that of the printed circuit board 122 of the protective circuit module 120, and the side wall 144 may be integrally formed with the cover plate 142 at the top of the cover plate 142. The side wall 144 may have a circumference that is smaller than the entire circumference of the cover plate 142.

Accordingly, even after the reinforcement sheath 150 surrounds not only the side portions of the pouch-type bare cell 110 and the top case 130 but also a side portion of the bottom case 140, the polymer battery pack 100 may have an entirely flat outer surface.

A plurality of projections (e.g., coupling projections) 1442 (for attachment of the reinforcement sheath 150) may also be formed on the side wall 144 of the bottom case 140.

The reinforcement sheath 150 according to an embodiment may surround the side portions of the pouch-type bare cell 110 the top case 130 and the bottom case 140, and a plurality of grooves or holes 152 and 154 coupled to the plurality of projections 1342 and 1442 may be formed at upper and lower ends of the reinforcement sheath 150, respectively. In an implementation, the coupling holes 152 and 154 may be holes penetrating completely through the reinforcement sheath 150. In an implementation, the coupling holes 152 and 154 may be holes only partially penetrating the reinforcement sheath 150. In an implementation, a diameter of a portion of each coupling projection 1342 and 1442 in each coupling hole 152 and 154 may be smaller than a diameter of each coupling hole 152 and 154.

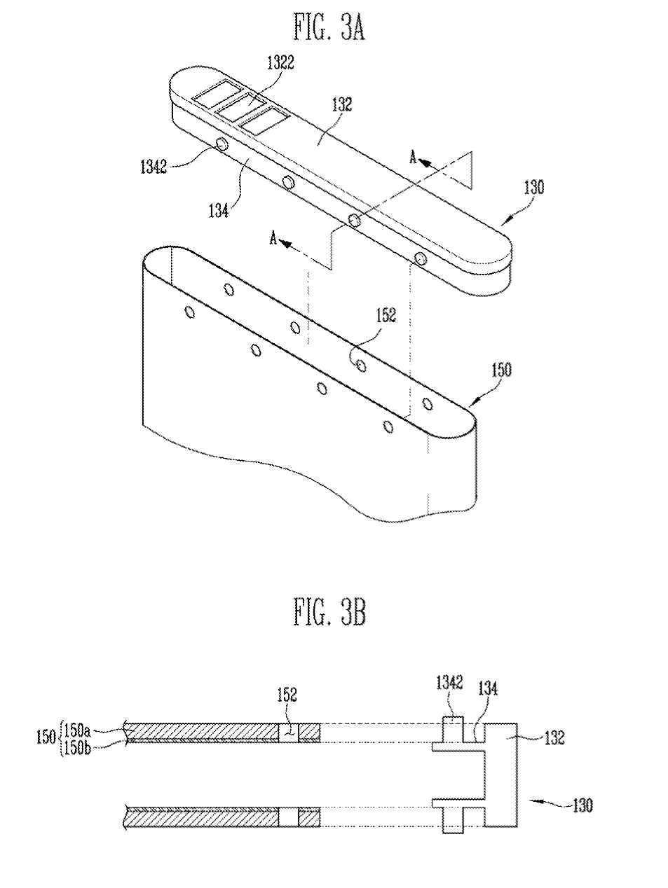

Hereinafter, a process of attaching the reinforcement sheath 150 to the top and bottom cases 130 and 140 according to an embodiment will be described in detail with reference to FIGS. 3 to 5.

FIG. 3 illustrates a view showing in detail the top case 130 and the reinforcement sheath 150 in the polymer battery pack 100 according to the embodiment. For example, FIG. 3A illustrates a partial exploded perspective view of the top case 130 and the reinforcement sheath 150 and FIG. 3B illustrates a partial section view of the top case 130 and the reinforcement sheath 150.

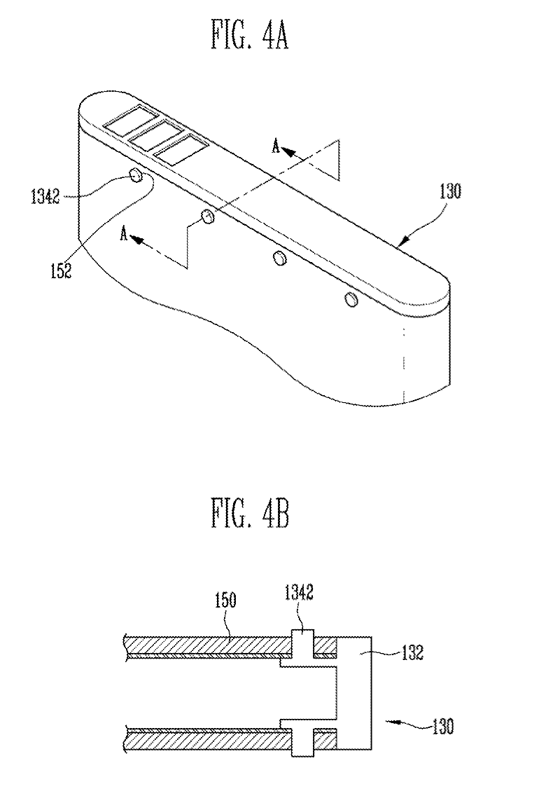

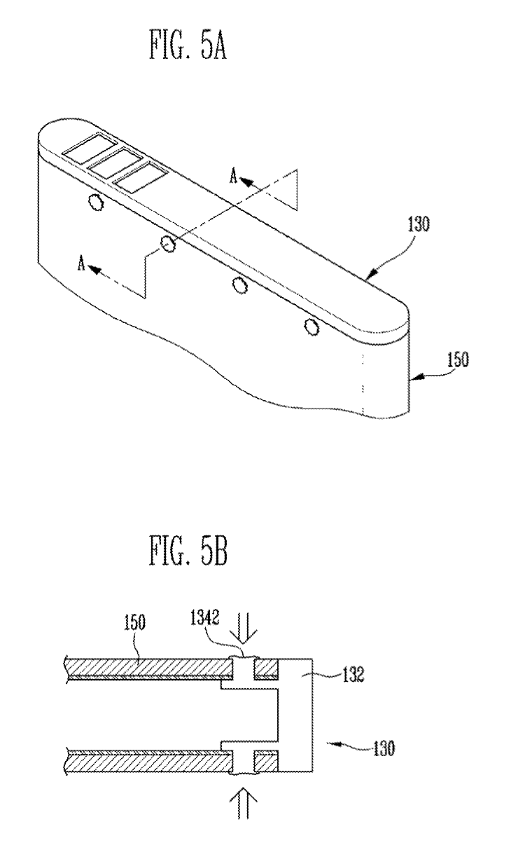

FIG. 4 illustrates a state in which the reinforcement sheath 150 surrounds the top case 130 according to the embodiment. For example, FIG. 4A illustrates an intermediate perspective view of the top case 130 and the reinforcement sheath 150 and FIG. 4B illustrates an intermediate sectional view of the top case 130 and the reinforcement sheath 150. FIG. 5 illustrates a state after the plurality of projections 1342 of the top case 130 are thermally compressed according to the embodiment. For example, FIG. 5A illustrates an assembled perspective view of the top case 130 and the reinforcement sheath 150 and FIG. 5B illustrates an assembled sectional view of the top case 130 and the reinforcement sheath 150.

As shown in FIGS. 3 to 5, as the reinforcement sheath 150 surrounds the side portion of the top case 130, the plurality of projections 1342 (hereinafter, referred to as a ‘plurality of first projections’ for convenience of illustration) of the top case 130 may be respectively mounted in the plurality of holes 152 (hereinafter, referred to as a ‘plurality of first holes for convenience of illustration) of the reinforcement sheath 150.

To this end, as described above, the plurality of projections 1342 may be formed on the side portion, i.e., the side wall 134 of the top case 130, and the plurality of first holes 152 may be formed at the upper end of the reinforcement sheath 150.

The plurality of projections 1342 may have a size corresponding to that of the plurality of first holes 152. For example, the first projection 1342 and the first hole 152 may have sizes such that the first projection 1342 and the first hole 152 may be fitted to each other.

In an implementation, the reinforcement sheath 150 may be attached to the side portion of the top case 130 in such a manner that a head portion of the first projection 1342 mounted in the first hole 152 is thermally compressed. For example, the reinforcement sheath 150 may be rivet-fixed to the side portion of the top case 130 by the first projection 1342 coupled to the first hole 152. In an implementation, the first projection 1342 and the first hole 152 may have an intermediately fitting structure or a loosely fitting structure rather than a forcibly fitting structure.

In order to use the rivet-fixing manner through thermal compression, the first projection 1342 according to an embodiment may have a height that is greater than a depth of the first hole 152. For example, the first projection 1342 may have a height that is greater than the thickness of the reinforcement sheath 150.

Accordingly, the head portion of the first projection 1342 (mounted in the first hole 152) may protrude from or on the reinforcement sheath 150, and the reinforcement sheath 150 may be firmly fixed to the side portion of the top case 130 in a state in which the first projection 1342 corresponding to the protruded height is thermally compressed.

The side wall 134 may have a size smaller than the entire circumference of the cover plate 132, thereby forming a step difference with the cover plate 132. As described above, in an implementation, the step difference may be equal to the thickness of the reinforcement label 150. As a result, the height of the first projection 1342 according to this embodiment may be higher than the step difference between the cover plate 132 and the side wall 134.

In order to use the rivet-fixing coupling through thermal compression, the first projection 1342 according to this embodiment may be formed so that the size, e.g., diameter, of the head portion of the first projection 1342 after the thermal compression is greater than that of the first hole 152.

Although not shown in FIGS. 3 to 5, the process of attaching the reinforcement sheath 150 to the top case 130 may also be identically applied to the bottom case 140. For example, the process of attaching the reinforcement sheath 150 to the bottom case 140 may be identical to the process of attaching the reinforcement sheath 150 to the top case 130, except that the top case 130 is changed into the bottom case 140, and therefore, its repeated detailed description will be omitted.

In an implementation, the reinforcement sheath 150 may include a metal layer 150a, and an adhesive layer 150b may be formed on one surface of the metal layer. For example, the reinforcement sheath 150 may include the adhesive layer on an inner side thereof.

For example, the metal layer may help protect the polymer battery pack 100 from an external impact. In an implementation, the metal layer may be formed of a metal that has strong rigidity and is not corroded by external air, e.g., any one of aluminum, stainless steel, and copper.

For example, the metal layer may help secure a rigidity corresponding to a basic function of the reinforcement sheath 150.

The metal layer may be formed with or as a thin plate, and may be formed to a thickness to an extent where the metal layer protects the pouch-type bare cell from an external impact and does not increases the weight of the polymer battery pack so much.

The adhesive layer may be formed on one surface of the metal layer, and may provide an additional bonding force in addition to the bonding force through the rivet fixing manner of the present invention.

In this case, the adhesive layer may be formed of, e.g., polyamide (PA) or polypropylene (PP), or the same material as that of the top case 130, so that the reinforcement sheath 150 may be attached to the side portions of the pouch-type bare cell 110 and the top case 130. In an implementation, adhesives made of various materials for improving attachment performance may be used.

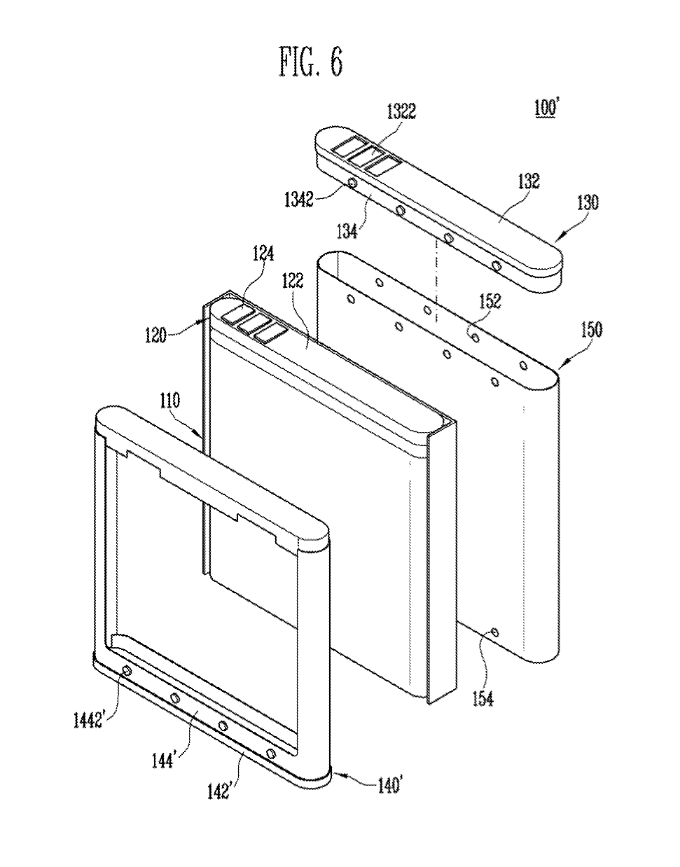

FIG. 6 illustrates an exploded perspective view of a polymer battery pack 100′ according to another embodiment.

As shown in FIG. 6, the polymer battery pack 100′ according to this embodiment may include a, e.g., frame-shaped, frame case 140′ in place of the bottom case 140.

In this case, the contents described in FIGS. 1 to 5 may be applied to this embodiment as they are, except that side and upper frame structures are added in the bottom case 140 described above in order to reinforce the pouch-type bare cell 110.

For example, a cover plate 142′ is positioned at the bottom end of the frame case 140′, and a side wall 144′ integrally formed with the cover plate 142′ may have a size smaller than the circumference of the cover plate 142′ at the top of the cover plate 142′. In an implementation, the side wall 144′ may extend up to left/right and upper side portions of the pouch-type bare cell 110. For example, the side wall 144′ of the bottom case may include a narrow-side extension part, the narrow-side extension part extending from the bottom cover plate 142′ along narrow sides of the bare cell 110. In an implementation, the narrow-side extension part of the bottom or frame case 140′ may be coupled with narrow sides of the top case 130.

In addition, a plurality of second projections (e.g., coupling projections) 1442′ (respectively corresponding to a plurality of second holes 154) may be formed at a lower end portion of the side wall 144′ to be respectively mounted in the plurality of second holes 154. As described above, a head portion of each of the plurality of second projections 1442′ may be thermally compressed, so that the reinforcement sheath 150 may be attached to the frame 140′.

As such, the process of attaching the reinforcement sheath 150 according to the aforementioned embodiment may be applied to the polymer battery pack 100′ including the frame-shaped frame case 140′. When the process is applied to the frame case 140′, it is possible to more stably protect the pouch-type bare cell 110 from an external impact.

By way of summation and review, in some polymer battery packs, the strength of a pouch constituting a bare cell and a plastic case surrounding the pouch may be weak, and the polymer battery pack may be easily damaged by external impact such as bending, distortion, or falling. Therefore, stability and reliability of the polymer battery pack may be deteriorated.

Other polymer battery packs may include a lithium polymer battery in which a protective circuit module is connected to a pouch-type bare cell, a case configured to accommodate the lithium polymer battery therein, and the like.

For example, aluminum used in the pouch may have a foil shape having a very thin thickness, and the plastic case surrounding the pouch may also have a very thin thickness. Hence, the strength of the pouch and the plastic case may be weak, and therefore, the polymer battery pack may be easily deformed, broken, or damaged by an external force.

Accordingly, the other polymer battery pack may be manufactured by separately attaching a reinforcement member made of a stainless steel material for strength reinforcement to the pouch-type bare cell connected to the protective circuit module, covering the pouch-type bare cell with the plastic case and then attaching a label paper around the pouch-type bare cell to which the plastic case is coupled.

However, the reinforcement member made of the stainless steel material may have a predetermined thickness and weight, and therefore, may not be suitable for the tendency of slimness and compactness of battery packs. In addition, the battery pack may require a separate reinforcement member made of a stainless steel material, and therefore, the manufacturing cost of the battery pack and the number of processes may be increased.

Replacing the label paper with a reinforcement member made of a stainless steel material may be considered.

For example, a label made of a metal material may be used as the label paper. In this case, the metal label may be attached around the pouch-type bare cell to which the plastic case is coupled, thereby reinforcing the strength of the pouch-type bare cell.

In order to bond the metal label to a top case, an adhesive having the same component as the top case may be applied to an inside of the metal label, and an outside of the top case and the inside of the metal label are bonded through thermal fusion.

However, in the bonding method, the thermal fusion may be performed on a relatively wide area. Hence, if any one portion is not thermally fused, the strength of the battery pack may be deteriorated. Therefore, a fusion device or structure may be complicated and increased in size so as to perform the thermal fusion on a wide area.

The embodiments may provide a polymer battery pack that may help ensure the reliability of attachment when a metal label for strength reinforcement is attached to a pouch-type cell, and that may help reduce a manufacturing cost and the number of processes.

According to an embodiment, reliability of attachment may be ensured when a metal label for strength reinforcement is attached to the pouch-type cell.

According to an embodiment, it is possible to reduce a manufacturing cost and the number of processes.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a pouch battery cell;
a protective circuit module on a top side of the battery cell;
a top case on the protective circuit module, the top case including a plurality of first coupling projections extending laterally outwardly therefrom; and
a reinforcement sheath, the reinforcement sheath including a plurality of coupling holes therein,
wherein the first coupling projections are in first coupling holes of the plurality of coupling holes, and the first coupling projections, together with the first coupling holes, couple the top case with the reinforcement sheath.

2. The battery pack as claimed in claim 1, wherein:
the top case includes:
a cover plate overlying the protective circuit module such that the protective circuit module is between the battery cell and the cover plate, and
a side wall extending from the cover plate toward the battery cell, and
the plurality of first coupling projections extend from the side wall.

3. The battery pack as claimed in claim 2, wherein an outer side of the side wall has a circumference that is less than a circumference of a parallel outer side of the cover plate.

4. The battery pack as claimed in claim 3, wherein the outer side of the side wall is stepped inwardly by a first distance with respect to the outer side of the cover plate.

5. The battery pack as claimed in claim 4, wherein the first distance is about equal to a thickness of the reinforcement sheath.

6. The battery pack as claimed in claim 5, wherein a height of each first coupling projection from the side wall is greater than the thickness of the reinforcement sheath.

7. The battery pack as claimed in claim 2, wherein each first coupling projection has a height from the side wall that is greater than a depth of each first coupling hole.

8. The battery pack as claimed in claim 1, wherein the first coupling projections are riveted with the first coupling holes such that an outer end of each first coupling projection is flattened and has a diameter that is greater than a diameter of each first coupling hole.

9. The battery pack as claimed in claim 8, wherein the flattened ends of the first coupling projections protrude from an otherwise flat outer surface of the battery pack.

10. The battery pack as claimed in claim 1, wherein the reinforcement sheath includes a metal layer.

11. The battery pack as claimed in claim 10, wherein the metal layer includes aluminum, stainless steel, or copper.

12. The battery pack as claimed in claim 10, wherein the reinforcement sheath includes an adhesive layer on an inner side thereof.

13. The battery pack as claimed in claim 12, wherein the adhesive layer includes a material that is the same as a material included in the top case.

14. The battery pack as claimed in claim 1, further comprising a bottom case on the battery cell, the bottom case being on a side of the battery cell that is opposite to the top case.

15. The battery pack as claimed in claim 14, wherein:
the bottom case includes a plurality of second coupling projections extending laterally outwardly therefrom, and
the plurality of second coupling projections are in second coupling holes of the plurality of coupling holes.

16. The battery pack as claimed in claim 15, wherein:
the bottom case includes:
a bottom cover plate on the battery cell such that the battery cell is between the bottom cover plate and the top case, and
a side wall extending from the cover plate toward the top case, and the plurality of second coupling projections extend from the side wall.

17. The battery pack as claimed in claim 16, wherein the side wall of the bottom case includes a narrow-side extension part, the narrow-side extension part extending from the bottom cover plate along narrow sides of the battery cell.

18. The battery pack as claimed in claim 17, wherein the narrow-side extension part of the bottom case is coupled with narrow sides of the top case.

19. The battery pack as claimed in claim 1, wherein the coupling holes are:
holes penetrating completely through the reinforcement sheath, or
holes only partially penetrating the reinforcement sheath.

20. The battery pack as claimed in claim 1, wherein a diameter of a portion of each first coupling projection in each first coupling hole is smaller than a diameter of each coupling hole.
